(19) United States
(12) Patent Application Publication
(10) Pub. No.: US 2011/0268897 A1
(43) Pub. Date: Nov. 3, 2011

(54) Full Color, Inkjet-Printable, Self-Laminating Label

(75) Inventor: Bruce M. Klemann, Shorewood, WI (US)

(73) Assignee: BRADY WORLDWIDE, INC., Milwaukee, WI (US)

(21) Appl. No.: 13/093,203

(22) Filed: Apr. 25, 2011

Related U.S. Application Data
(60) Provisional application No. 61/329,622, filed on Apr. 30, 2010.

(51) Int. Cl. G09F 3/10

(52) U.S. Cl. 428/32.19

(57) ABSTRACT

An inkjet-printable, self-laminating wire marker comprising:
A. A transparent substrate layer having top and bottom facial surfaces;
B. A topcoat layer having top and bottom facial surfaces with the bottom facial surface of the topcoat layer in direct contact with at least a part but not all of the top facial surface of the substrate layer;
C. A transparent adhesive layer having top and bottom facial surfaces with the top facial surface of the adhesive layer in direct contact with the bottom facial surface of the substrate layer.
   In one embodiment an opaque white primer layer having top and bottom facial surfaces is interposed between the substrate and topcoat layers such that the bottom facial surface of the primer layer is in direct contact with the top facial surface of the substrate layer and the top facial surface of the primer layer is in direct contact with the bottom facial surface of the topcoat.

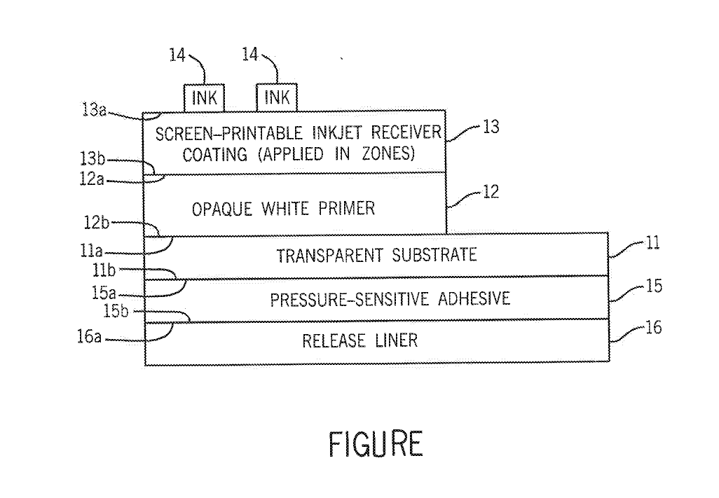

### CROSS REFERENCE TO RELATED APPLICATION

The present application claims priority to U.S. patent application Ser. 61/329,622, filed on Apr. 30, 2010, the entire content of which is incorporated by reference herein.

### FIELD OF THE INVENTION

This invention relates to labels. In one aspect, the invention relates to labels for use as wire markers while in another aspect, the invention relates to inkjet-printable, self-laminating wire marker labels. In yet another aspect the invention relates to inkjet-printable, self-laminating wire marker labels that are capable of rendering hill color images.

### BACKGROUND OF THE INVENTION

The art is replete with wire marker labels that are printable by various technologies, but none print well enough with aqueous inkjet inks to render full color images. Current wire markers that are printable with aqueous inkjet inks have relatively low ink absorption thus limiting their use to printing of monochrome black images of low density. The art has a continuing interest in identifying and developing wire markers with better ink absorption capacity, better image resolution and better opacity such the markers can be printed with aqueous inkjet inks to produce full color images that are solvent and abrasion resistant.

### BRIEF SUMMARY OF THE INVENTION

In one embodiment the invention is an inkjet-printable, self-laminating label that is capable of rendering a full color image. While the invention is described in terms of wire marker labels, which is a preferred embodiment of the invention, the labels of this invention are also useful in any application in which self-lamination is a useful feature, e.g., the labeling of pipe.

In one embodiment the invention is an inkjet-printable, self-laminating wire marker comprising:

A. A translucent, preferably a transparent, substrate layer having top or first and bottom or second facial surfaces;

B. A topcoat layer having top or first and bottom or second facial surfaces with the bottom facial surface of the topcoat layer in direct contact with at least a part but not all of the top facial surface of the substrate layer, the top coat layer comprising (I) pigment particles having (a) a number average particle size of 1 to 25 microns (μm), and (b) at least one of (i) an oil absorption value of at least 150 grams per 100 grams of particles (g/100 g), and (ii) a pore volume of at least 1.2 cubic centimeters per gram (cm³/g), and (2) water-insoluble binder resin having a surface energy greater than 42 dyne per centimeter (dyn/cm), the pigment particles and binder resin present at a weight ratio of at least 0.6; and

C. A translucent, preferably a transparent, adhesive layer having top or first and bottom or second facial surfaces with the top facial surface of the adhesive layer in direct contact with the bottom facial surface of the substrate layer; and

D. An optional release liner having top or first and bottom or second facial surfaces with the top facial surface of the optional release liner in direct contact with the bottom facial surface of the adhesive layer.

Essentially any translucent or transparent film can be used for the substrate. The topcoat layer has sufficient absorption capacity to absorb aqueous inkjet ink so as to provide full color imaging, and it is typically applied in zones (as opposed to complete coverage) over the top facial surface of substrate layer. The adhesive is typically and preferably a pressure sensitive adhesive.

In one embodiment an opaque white primer layer having top or first and bottom or second facial surfaces is interposed between the substrate and topcoat layers such that the bottom facial surface of the primer layer is in direct contact with the top facial surface of the substrate layer and the top facial surface of the primer layer is in direct contact with the bottom facial surface of the topcoat. Any white ink that is printable by flexography or screen printing can be used as the primer.

### BRIEF DESCRIPTION OF THE FIGURE

The FIGURE is a schematic of an inkjet-printable, self-laminating wire marker label that is capable of rendering a full color image.

### DETAILED DESCRIPTION OF THE PREFERRED EMBODIMENT

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, weight and/or thickness ranges, etc., is from 100 to 1,000, then the intent is that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, the thickness of the individual layers.

“Facial surface”, “planar surface”, “top surface”, “bottom surface” and the like are used in distinction to “edge surface”. If rectangular in shape or configuration, a label will comprise two opposing facial surfaces joined by four edge surfaces (two opposing pairs of edge surfaces, each pair intersecting the other pair at right angles). If circular in configuration, then the label will comprise two opposing facial surfaces joined by one continuous edge surface. The labels can be of any size and shape and as such, so can the facial and edge surfaces, e.g., thin or thick, polygonal or circular, flat or wavy, etc.

“Wire marker” and like terms mean a label or tag that is attached to a wire or cable for purposes of identifying it and/or or its purpose.

“Ink” and like terms mean a coatable or printable formulation containing one or more dyes and/or pigments.

“Inkjet-printable” and like terms mean that the printable area of the label, i.e., the topcoat layer, is capable of absorbing a large quantity of aqueous inkjet inks. The quantity of ink absorbed is sufficient to allow for rendering of images with commercial inkjet printers.

“Self-laminating” and like terms mean label constructions which have a translucent or transparent substrate and adhesive and an opaque topcoat that is coated onto the substrate in one or more zones, rather than covering the entire surface. The wire or other object to be labeled is wrapped with the label starting from the end of the label with the opaque, printable zone. Continuation of wrapping of the wire with the translucent or transparent portion of the label covers the printable area and protects it. Unlike typical over-laminate films, which are applied on top of a label or graphics in a separate operation, the self-laminating label and the over-laminate “tail” are applied as one single, continuous label.

“Full color image” and like terms mean images that are printed in multiple colors, most often, images that are printed using a process color set of inks, such as cyan-magenta-yellow-black (CMYK), or ink sets with even more colors that include secondary colors such as green and orange; light versions of cyan, magenta, and black; or “spot color” inks specifically designed to match a standard color (such as a Pantone color).

“Transparent” and like terms mean that light is transmitted through the film such as not to blur or obscure images or information on the underlying layers.

“Translucent” and like terms mean that light is transmitted through the film such as to blur the images or information on the underlying layers.

The invention is described generally with reference to the FIGURE for the purpose of illustrating certain embodiments only, and not for the purpose of limiting the scope of the invention.

The FIGURE is a schematic of one embodiment of an inkjet-printable, self-laminating wire marker of this invention. Self-laminating marker 10 comprises transparent substrate layer 11 which comprises top or first facial surface 11a and bottom or second facial surface 11b. Top facial surface 11a is printed or otherwise partially but not completely covered with opaque white primer layer 12 such that bottom or second facial surface 12b of primer layer 12 is in direct contact with top facial surface 11a. Top or first facial surface 12a is printed or otherwise coated with topcoat layer 13 such that bottom or second facial surface 13b is in direct contact with top facial surface 12a. Upon printing inkjet printer ink 14 is in direct contact with topcoat 13 (due to the porosity of topcoat 13, ink 14 is absorbed into the topcoat as opposed to simply remaining in direct contact with top facial surface 13a).

Beneath substrate layer 11 is adhesive layer 15 such that top or first facial surface 15a is in direct contact with bottom facial surface 11b. Beneath adhesive layer 15 is optional release liner 16 such that top or first facial surface 16a is in direct contact with bottom facial surface 15b. In the marker construction of the FIGURE, top facial surface 13a is over-laminated with adhesive layer 15 and substrate layer 11 such that the part or zone of top facial surface 11a of substrate layer 11 is open to the environment.

### Topcoat Layer

Although the topcoat layer may accept and hold an ink from a thermal transfer printer, laser printer or another printer other than an inkjet printer, it must be able to accept and hold an aqueous ink or other marking composition from an inkjet printer to be usable in the practice of this invention. The topcoat layer must be thick enough and have enough absorption capacity (porosity) to absorb and hold the inkjet ink. Topcoats that are too thick fail due to binder migration, i.e., the binder in each layer migrates to the surface closest to the ink. This results in a non-uniform distribution of the binder in the respective layers of the topcoat and this, in turn, results in poor printing performance, low adhesion to the substrate, and/or lack of mechanical integrity. Accordingly, the thickness (expressed as coating weight) of the topcoat layer is 8 to 40, preferably 12 to 30 and more preferably 15 to 25, g/m². The thicker the layers, typically the slower the line speed for the coating application. The topcoat layer is typically highly opaque when dry, but becomes translucent in service when immersed in water or solvents that fill the pore structure of the coating. The optional white primer layer helps diminish this loss of opacity.

The topcoat can be applied to the substrate or support in any manner in which coated zones may be created, conventional or otherwise. Typically the printable topcoat is applied to the transparent substrate by flexography, gravure, or screen printing. The mixture or blend from which the printable topcoat layer is coated on or otherwise applied to the substrate or primer, and the mixture or blend from which the printable topcoat layer is coated on or otherwise applied to the base layer can be prepared using any conventional mixing or blending technique and equipment.

In one embodiment the topcoat layer can comprise two or more sublayers in which all layers are compositionally the same or one or more sublayers differ compositionally for one or all of the other sublayers. In one embodiment the topcoat layer comprises a basecoat layer and an imaging layer, the former designed primarily for receiving and holding the ink and the latter designed primarily for brightening colors and/or sharpening images. Sublayers are also useful in building the overall thickness of the topcoat layer.

The binder resin of the topcoat layer can be used crosslinked or uncrosslinked. For organic solvent resistance and good mechanical performance and weatherability, typically the binder resin is at least partially crosslinked. The binder resin can be crosslinked using any conventional technology, e.g., radiation, heat, moisture, peroxide, etc. Crosslinking can occur before, during or after printing.

The high pore volume of the large pigment particles, along with a high pigment to binder ratio, allows the topcoat to absorb and hold a large (e.g., 10-30 ml/m²) amount of aqueous inkjet ink liquid. The ink absorption rate increases as the surface energy of the binder resin increases. High ink absorption rates allow prints to dry quickly without puddling or undesirable mixing of colors. The binder resin component imparts water-insolubility, crosslinking of the binder resin imparts organic solvent insolubility, and the hard pigment particles impart strong abrasion resistance. The high pore volume of the particles, particularly silica particles, allows the layer to hold a large amount of liquid from the inkjet inks which increases the reflected optical density of the prints. The incorporation of ultraviolet (UV) light stabilizers and the like impart good weatherability,

### Pigment Particles

In those embodiments in which water-resistance is an important property of the label, the polymeric binder resins used in the practice of this invention do not dissolve in or absorb a significant quantity of water. Consequently, pigment particles with extensive pore structures are used to create porosity in the coating and capacity for holding the water and water-miscible components present in the ink.

If pigment particles are systematically added to a binder, eventually a point is reached at which there is no longer enough binder to fill all of the space between the pigment particles. This is the critical pigment volume concentration or CPVC (T. C. Patton, Paint Flow and Pigment Dispersion, 2nd ed., Wiley-Interscience, 1979), a key quantity well known to those skilled in the art. As the ratio of pigment to binder increases above the CPVC, the amount of void space in the coating increases. Thus, the coating must have void space above the CPVC in order to be absorptive if the binder is not absorptive. The pigment particle to binder resin ratio in the topcoat layer of this invention is in the range of 0.60 to 5. For the printable topcoat layer, this ratio is preferably in the range of 0.75 to 1.20.

The pigment particles used in the practice of this invention have a large absorption capacity which is commonly defined by their oil absorption value. The pigment particles have an oil absorption value greater than (>) 150, preferably >250 and more preferably >300, g oil/100 g pigment particles. In one embodiment the oil absorption value correlates to a specific pore volume of at least 1.2, preferably at least 1.5 and more preferably at least 1.8, cm³/g. Generally, the higher the oil absorption, the more preferred the pigment although as a practical matter the oil absorption value does not exceed 3 cm³/g. The method for measuring the oil absorption value is set forth in ASTM D281-95.

Many different absorptive inorganic pigments useful in the practice of this invention are identified in the paper coating literature. These materials include calcium carbonate, precipitated silica, fumed silica, silica gel, alumina, boehmite, pseudo-boehmite (U.S. Pat. No. 5,104,730), aluminum hydroxide, basic magnesium carbonate and amorphous magnesium carbonate. Sol-gel coatings obtained by hydrolysis of alkoxides of silicon or aluminum are another class of materials suitable for use in this invention. Preferred materials are sometimes referred to as “flatting agents”.

In one embodiment the pigment particles comprise silica. Silica particles for use in the topcoat layer include, but are not limited to, Syloid C803, Syloid C805, Syloid C807, Syloid C809, Syloid C812, Syloid C816, Sylojet P405, Sylojet P407, Sylojet P409, Sylojet P412, Sylojet P416, Syloid W300, Syloid W500, Syloid 74, Syloid 234, Syloid 620, Syloid 4500, Syloid 5500, Syloid 6000 and Syloid 6500 all available from W. R. Grace; Sylysia 250, Sylysia 250N, Sylysia 270, Sylysia 290, Sylysia 310P, Sylysia 320, Sylysia 350, Sylysia 370, Sylysia 380, Sylysia 390, Sylysia 420, Sylysia 430, Sylysia 440, Sylysia 450, Sylysia 460, and Sylysia 470, all available from Fuji Sylysia; and Gasil HP220, Gasil HP39, and Gasil IJ45 available from Ineos Silicas. Preferred pigments for the topcoat layer include Syloid C805, Syloid C807, Syloid C809, Syloid C812, Sylojet P405, Sylojet P407, Sylojet P409, Sylojet P412, Syloid W500, Sylysia 320, and Sylysia 350. In general, silicas with large particle size and narrow particle size distribution give coatings with more inter-particle void space and better ink absorption than silicas with small particle size and/or broad particle size distribution.

One method for selectively producing high, e.g., 1.2 to 3.0 cm³/g, pore volume silica gel, is described in U.S. Pat. No. 3,959,174. The method uses alkaline gelation to control the silicate concentration. It uses a de-solubilizing substance such as ammonium hydroxide, sodium sulfate or other such salt to decrease the solubility of silica. The silica concentration is maintained at 3 to 15 percent, the silica to de-solubilizing agent ratio at 2 to 20, and the gelation pH at 10.6 to 11.2. The gelled silica is then aged, neutralized, filtered, optionally aged a second time, and washed. For use in this invention the preferred values are in the range of 8 to 12 percent, more preferably 10 percent, for SiO₂ and the SiO₂/NH₃ ratio is in the range of 4 to 8, preferably 6. After washing and filtering and prior to re-slurrying, the silica is dried. This may be oven drying or spray drying. This drying forms particle agglomerates of greater than 25 microns. The agglomerated silica is fed into a fluid energy mill, preferable of the micronizer or jet pulverizer type. When the particles are at a predetermined size. e.g., 1 to 25 microns, they are collected from the mill.

For the pigment particles used in the topcoat layer, the number average particle size is 0.3 to 25, preferably 2 to 16, microns. Number average particle size is measured by dynamic light scattering over a range of 1 micron to hundreds or thousands of microns using such equipment as the Horiba LA-950V2.

### Binder Resin

The binder resins of this invention typically have surface energies greater than (>) 40, more typically >42, preferably >44 and even more preferably >45 dyne/cm. Although the only limits on the maximum surface energy of the binder resin are practical limits, e.g., availability, processability, cost, etc., typically the maximum surface energy of the binder resin is 65, more typically 60 or even or more typically 55, dyne/cm. As the surface energy of the coating increases, the spreading coefficient, which may be defined as the decrease in free energy as the surface is covered with a film of liquid (see S. Wu, Polymer Interface and Adhesion, Marcel Dekker, 1982), increases. Physically this means that the rate of ink spread on the substrate increases. The increase in coating surface energy manifests itself in color print density increases due to greater spread, or “dot gain”, of the jetted ink droplets on the surface and increases in the rate of ink, absorption as the ink spreads more rapidly into the capillaries of the porous coating. Swift ink absorption not only allows the print to be handled as soon as it comes off the printer, but for some wide-format ink jet printers the ink must dry within a few seconds or it will be smeared by handling or by rollers in the paper feed systems that may be only a few inches away from the print-head.

The surface energy of a flat film of binder resin is measured by ASTM D2578-08. This test employs mixtures of formamide and ethyl CELLOSOLVE™ (ethylene glycol monoethyl ether available from The Dow Chemical Company) over the range of 30-56 dyn/cm. Test kits are available from Diversified Enterprises under the name AccuDyne Test Surface Tension Test Fluids.

The pigment particle and binder resin are typically present at a pigment/binder weight ratio of at least 0.6, more typically of at least 0.7 and even more typically of at least 0.8. Although the only limits on the maximum pigment/binder weight ratio are practical limits, e.g., composition and compatibility of the pigments and binder, composition of the substrate layer, processability, cost, etc., typically the maximum pigment/binder weight ratio is 5, more typically 4 and even more typically 3.

Alcohol-Soluble Binder Resins

In one embodiment of this invention, the binder resin comprises a non-cationic, alcohol-soluble, water-insoluble compound dissolved in an alcoholic liquid medium. In this embodiment the binder resin is preferably soluble to a concentration of at least 5 weight percent (wt %) in the alcohol or alcohol mixture used to prepare the recording media coating composition.

The alcoholic liquid medium has a boiling point less than 150° C., preferably less than 140° C., more preferably less than 120° C., and has a viscosity of up to 100 MegaPascals (MPa), preferably up to 50 MPa. The alcohols are not a solvent for the support or substrate to which the coating composition is applied, although they may swell the support to some extent. Suitable alcohols include hydrocarbon compounds having at least one carbon atom and at least one hydroxy group. They can have a wide range of carbon atoms and hydroxy groups. Preferably, however, the alcohol has less than 15 carbon atoms and less than 4 hydroxy groups. These alcohols may have other hetero atoms besides those contributed by the hydroxy group(s), and these groups can be primary, secondary or tertiary to the hydrocarbon moiety such as their valence allows so long as it does not become a solvent for the support.

Due to the polar nature of most binder resins, polar hydrocarbon liquids with hydroxyl groups are preferred alcoholic liquid media. Straight chain primary and secondary alcohols ranging from 1 to 6 carbon atoms in length, such as methanol, ethanol, propanol, n-butanol, 2-butanol, isopropanol, and so forth, are preferred. Tertiary alcohols such as diacetone alcohol are also appropriate. Glycol ethers such as diethylene glycol monobutyl ether, ethylene glycol monobutyl ether and propylene glycol monomethyl ether may also be included in the composition as alcoholic liquid media. The solvent composition of the coating composition may include up to 40 percent water and minor amounts of other organic solvents.

One preferred class of suitable alcohol-soluble binder resins are alcohol-soluble polyamides. Typical alcohol-soluble polyamides and methods of obtaining them are disclosed in U.S. Pat. Nos. 2,285,009; 2,320,088; 2,388,035; 2,393,972; 2,450,940 and 3,637,550. Preferred alcohol-soluble polyamides include alcohol-soluble melt-polymerized polyamides consisting essentially of recurring carboxamido groups and at least two different species of recurring hydrocarbylene groups selected from the group consisting of aliphatic and alicyclic groups of 2 to 40 carbon atoms as integral parts of the main polymer chain, and having at least 3 different recurring polyamide repeat units.

Preferred among such polyamides are those in which (a) 33-100 mole percent (mol %) of the imine groups are derived from polymethylene diamine of 6 to 20 carbons, (b) 5-65 mol % of the carbonyl groups are derived from dimerized fatty acids of 16 to 48 carbon atoms, (c) 8-65 mol % of the carbonyl groups are derived from polymethylene diacid of 6 to 18 carbon atoms, and (d) 8-65 mol % of the carbonyl groups are derived from monomers selected from the group consisting of (1) polymethylene diacid of 6 to 18 carbon atoms which is different from diacid (c), and (2) polymethylene omega-amino acid of 6 to 18 carbon atoms. These polyamides have an annealed heat of fusion of 5 to 18 calories per gram, are quenchable to the amorphous state at a cooling rate of 100° C. per minute, and have an upper glass transition temperature in the amorphous state of less than 30° C.

One particularly preferred class of polyamides includes those in which (1) 98-100 mol % of the imine groups are derived from hexamethylene diamine, (h) 15-55, and preferably 25-55, mol % of the carbonyl groups are derived from dimerized fatty acid of 36 carbon atoms, (c) 10-45, and preferably 15-45, mol % of the carbonyl groups or derived from adipic acid, and (d) 15-55, and preferably 15-45, mol % of the carbonyl groups are derived from polymethylene diacid of 10 to 12 carbon atoms. Most preferably, these polyamides have a minimum flow temperature of 160 to 210° C.

Suitable polymethylene diamines for preparing suitable polyamides include hexamethylene diamine, heptamethylene diamine, octamethylene diamine, nonamethylene diamine, decamethylene diamine, undecamethylene diamine, dodecamethylene diamine, tridecamethylene diamine, and octadecamethylene diamines. Suitable polymethylene diacids for preparing suitable polyamides include adipic, pimelic, suberic, azelaic, sebacic, dodecanedioic, brassylic, tetradecandioic and octadecanedioic acids. Suitable amino acids include 6-aminocaproic, 7-aminoheptanoic, 8-aminocaprylic, 9-aminononanoic, 10-aminodecanoic, 11-aminoundecanoic, 17-aminoheptadecanoic, and the like.

By “dimerized fatty acid of 16 to 48 carbons” is meant dimers derived from fatty acids of 8 to 24 carbons. These dimerized fatty acids are commercially available materials which have been fully described in the literature including U.S. Pat. Nos. 3,157,681 and 3,256,304. These dimerized fatty acids are obtained by catalytic or non-catalytic polymerization of ethylenically unsaturated fatty acids.

The method of forming polyamides by melt-condensation is well known to those skilled in the art. This polymerization reaction is described, for example, in U.S. Pat. Nos. 2,252,554 and 2,285,009 and British Patent 1 055 676. The reaction is carried out by polyamide forming derivatives, and, if desired, amino acids or their polyamide-forming derivatives at temperatures of about 150 to 300° C. while driving off water and continuing the reaction until the desired molecular weight is obtained. The resulting polyamide contains substantially equimolar amounts of carbonyl groups and imine groups. The polymer end groups are carboxylic acid and amine, one of which may be in slight excess depending upon which reactant was present in excess. Preferably the polymer contains at least as many amine ends as carboxyl ends.

These polyamides and their method of manufacture are described in more detail in U.S. Pat. No. 3,637,550. Specific examples of this type of polyamide include ELVAMIDE® nylon terpolymer resins available from E.I. DuPont de Nemours, Inc., and custom nylon terpolymer resin solutions available from General Plastics Corporation. Preferred binder resins include ELVAMIDE 8023, ELVAMIDE 8061, ELVAMIDE 8061A, ELVAMIDE 8061M and ELVAMIDE 8066. Particularly preferred binder resins are solutions of ELVAMIDE® 8063 nylon terpolymer in blends of low molecular weight aliphatic alcohols and water.

Additional preferred alcohol-soluble polyamides are those prepared by condensing a monocarboxylic acid, diamine and dimerized fatty acid as described in U.S. Pat. Re. 28,533; those prepared by condensing an acid component of dimerized fatty acids, at least one aliphatic unbranched monocarboxylic acid, and at least one aliphatic branched monocarboxylic acid with ethylene diamine and hexamethylene diamine as the amine component as described in U.S. Pat. No. 4,571,267; and those polyamide resin compositions that comprise the condensation reaction product of a C₃₆ dimerized fatty acid, at least one dibasic acid, at least one C₁₋₄ alkyl diamine and at least one piperazine-like diamine, the equivalents of amine groups being substantially equal to the equivalents of carboxyl groups, where 30 to 50 equivalent percent of the carboxyl groups are contributed by the dibasic acid component and 73 to 93 equivalent percent of the amine groups are contributed by the piperazine-like diamine component as described in U.S. Pat. No. 5,154,760. Specific examples of this type of polyamide resin include the UNI-REZ® fatty acid dimer-based polyamides developed by Union Camp Corporation.

Dispersed Binder Resin

In one embodiment of this invention, the binder resin composition is a dispersion of a non-cationic water-insoluble binder resin in an aqueous or alcoholic liquid medium. The alcoholic medium may be selected from among those described above as solvents for the resins which are soluble in alcoholic liquid media. The aqueous or alcoholic medium may be a mixture of an alcoholic medium with an aqueous media, and it may further comprise minor amounts of non-alcoholic organic solvents. In one embodiment the binder resin is an aqueous dispersion of a non-cationic water-insoluble polyamide. Aqueous polyamide dispersions that are useful in this invention include custom nylon terpolymer dispersions available from General Plastics Corporation under the GENTON trademark, and MICROMID fatty acid dimer-based polyamide dispersions available from Arizona Chemical.

Polyamides suitable for making aqueous dispersions include polymerized fatty acid polyamide resins which have been prepared so as to have a low acid and low amine number. The dispersion is typically prepared by heating the polyamide resin to a temperature at or above its melting point. The liquefied polymerized fatty acid polyamide resin is then blended with a predetermined amount of water which is heated to a temperature such that the resulting blend will have a temperature above the melting point of the polyamide resin. A surfactant, which may be anionic, nonionic or cationic, preferably nonionic, and which will promote the emulsification of the polyamide resin in water, is included in the mixture. The resulting mixture is then subjected to sufficient COMM muting forces to form an emulsion in which droplets of the polyamide resin have a volume average size distribution of 20 microns or less in diameter and preferably 5 microns or less. The resulting emulsion is then cooled to a temperature below the melting point of the polyamide resin causing the emulsified droplets of the polyamide resin to solidify as finely divided particles which are dispersed uniformly through the aqueous phase. The resulting aqueous dispersion is stable. This type of binder resin composition is described in U.S. Pat. No. 5,109,054.

Dispersions of many other binder resins with surface energies greater than 40 dyn/cm are also useful in the practice of this invention. These resins include ethylene acrylic acid (EAA) copolymers, ionomers, copolymers of poly-2-ethyl-2-oxazoline and acrylates, and polyurethanes. Preferred resins include EAA copolymer dispersions sold by Michelman, Inc under the MICHEM PRIME trademark, EAA copolymers sold by The Dow Chemical Company under the PRIMACOR trademark, EAA copolymer ionomer dispersions sold by Michelman, Inc under the MICHEM PRIME trademark, and polyurethanes sold under the WITCOBOND trademark. Particularly preferred resin dispersions include MICHEM PRIME 48525 ionomer, MICHEM PRIME 4893R EAA copolymer, MICHEM PRIME 4893-40R EAA copolymer, MICHEM PRIME 489345N ionomer, MICHEM PRIME 4990R copolymer, WITCOBOND W-213 polyurethane, and WITCOBOND W-240 polyurethane.

### Crosslinking Agents

In one embodiment, the binder resins are crosslinked in order to improve solvent resistance. For some of the binder resins useful in this invention, crosslinking may also improve water resistance. For polyamide resins, one preferred class of crosslinking agent is aziridine. One particularly preferred crosslinking agent is XAMA®-7 tri-functional aziridine from BASF. Preferably the EAA copolymer and ionomer resins, copolymers of poly-2-ethyl-2-oxazoline and acrylates, and polyurethanes are crosslinked with aziridine, isocyanate or melamine formaldehyde resin in order to obtain sufficient solvent resistance. Preferred crosslinking agents for these resins include XAMA®-2 and XAMA®-7 tri-functional aziridines from BASF, CYMEL® 385 and 373 partially alkylated melamines from Cytec Industries; RESIMENE® 717, 718, 741, 745, and 747 partially alkylated melamines from Ineos Melamines; BAYHYDUR 302, 303, 304, 305, 401-70, BL5335, VP LS 2150 BA, VP LS 2306, VP LS 2310, XP 2487/1, XP 2547, XP 7165 isocyanates from Bayer Material Science; and BASONAT HB 100, HI 100, HB 175 MP/X, and HB 275 B isocyanates from BASF. In some cases the melamine formaldehyde resins may require an acid catalyst such as p-toluene sulfonic acid. In some cases, the isocyanates may require the use of organometallic catalysts for initiation such as dibutyltin dilaurate.

### Topcoat Additives

The topcoat formulation can include one or more additives that impart beneficial properties to the topcoat. These properties may be particularly preferred when the topcoat is exposed to environmental conditions that are deleterious to the integrity of the image.

One such environmental condition is exposure to short wavelength radiation, such as the ultraviolet radiation contained in sunlight. Ultraviolet radiation is known to cause photochemical damage to coatings and color images, such as structural damage and fading or darkening of colors. Additives which are known to protect against degradation by ultraviolet radiation are generally classified as UV absorbers, light stabilizers and antioxidants. These additives are used in the manner and amounts as is well known in the art.

Examples of UV absorbers include compounds classified as derivatives of hydroxybenzotriazole, hydroxyhenzophenone, and triazines, such as hydroxylphenyl-s-triazines. Specific examples include TINUVIN™ 1130 from Ciba (a mixture of poly(oxy-1,2ethanediyl), .α-(3-(3-(2H-benzotriazol-2-yl)-5-(1,1-dimethylethyl)-4-hydroxyphenyl)-1-oxopropyl)-ω-hydroxy and poly(oxy-1,2 ethanediyl), α-(3-(3-(2H-benzotriazol-2-yl)-5-(1,1-dimethylethyl)-4-hydroxyphenyl)-1-oxopropyl)-ω-(3-(3-(2H-benzotriazol-2-yl)-5-(1,1-dimenthylethyl)-4-hydroxyphenyl)-1-oxopropoxy); TINUVIN 384 from Ciba, benzenepropanoic acid, 3-(2H-benzotriazol-2-yl)-5-(1,1-di-methylethyl)-4-hydroxy-, C7-9 branched an linear alkyl esters; TINUVIN 400 from Ciba, a mixture of 2-[4-[(2-hydroxy-3-dodecyloxypropyl)oxy]-2-hydroxyphenyl]-4,6-bis(2,4-dimethylphenyl)-1,3,5-triazine and 2-[4-[(2-hydroxy-3-tridecyloxypropyl)oxy]-2-hydroxyphenyl]-4,6-bis(2,4-dimethylphenyl)-1,3,5-triazine; TINUVIN 460 from Ciba, 2,4-bis(2-hydroxy-4-butoxyphenyl)-6-(2,4-bis-butoxyphenyl)-1,3,5-triazine; Tinuvin 477DF hydroxyl-phenyl-triazine from Ciba; CYASORB™ UV 24 from Cytec (a hydroxybenzophenone UV absorber); and CYASORB™ UV1164 also from Cytec (a UV absorber of the substituted s-triazine class).

The UV stabilizers are typically hindered amine light stabilizers (HALS). Specific examples include TINUVIN™ 123, 292 and 770 and CHIMASSORB™. 119 and 944FL, all from Ciba.

The antioxidants which are useful in the topcoat formulations of the present invention may be selected from a wide range of compounds, such as the phenolic antioxidants, e.g., hindered mono-phenols, diphenols, and poly-phenols, and phosphites and phosphonites. Examples of the phenolic antioxidants include the IRGANOX™ series from Ciba, such as IRGANOX™ 1098, and an example of the phosphite type antioxidant is IRGAFOS 168, also from Ciba. Interactions of the antioxidants with other components of the formulations may, however, form colored compounds in reactions with many crosslinkers, and thus may be unsuitable for certain formulations.

Further examples of UV absorbers, stabilizers and antioxidants that may be used as additives to the topcoat compositions according to this invention may be found in Chapter 2 of Oxidation Inhibition in Organic Materials (CRC Press, 1990, J. Pospisil et al., eds., pp. 29-462), entitled “Photo-oxidation of Polymers and its Inhibition” by Francois Gugumus; Modern Plastics Encyclopedia Handbook (McGraw Hill, 1994); “UV Stabilizer” by Pyong-Nae Son, pp. 119-120; European Patent Application 0 704,560; and U.S. Pat. Nos. 4,314,933 and 4,619,956.

Polyamide-based topcoats, when UV-stabilized with an additive package, are especially suitable for applications requiring outdoor weatherability in which a high degree of water-resistance is required. Additives appropriate to polyamides include s-triazine and hydroxy benzotriazole UV absorbers, hindered amine light stabilizers, and Phenolic and phosphite antioxidants. Best results are usually obtained when a combination of UV absorbers and hindered amines, are used as the combinations are often synergistic,

### Substrate Layer

The substrate layer can comprise any transparent film. Representative films include polyolefin (e.g., polyethylene, polypropylene, etc.), polyester (e.g., polyethylene terephthalate (PET), etc.), polyvinyl chloride (PVC, typically plasticized), polyamide, polyether, polyimide and the like. This layer serves to protect the graphics after the marker has been applied to a wire or cable. This layer is typically 6 to 125, preferably 12 to 100 and more preferably 25 to 90, μm in thickness.

The opaque white primer can comprise any white ink that is printable by flexography, gravure or screen printing. UV curable white inks for flexography and screen printing generally consist of (meth)acrylate monomers, (meth)acrylate oligomers, photoinitiators, and a white pigment such as titanium dioxide, zinc oxide, barium sulfate, magnesium carbonate, antimony tin oxide, basic lead carbonate, calcium carbonate, aluminum oxide, or kaolin. White primers may also be made from solutions or aqueous dispersions of polymers such as acrylics, polyurethanes, polyesters, polyamides, poly(vinyl chloride), epoxides, and ethylene-acrylic acid copolymers, to which a white pigment such as those mentioned above has been added. Representative UV curable primers include Zeller-Gmelin High Opacity White flexo UV DPS RH3025207, Sericol 850-311 OP White, and Sericol 650S37148SC. This layer enhances adhesion of the topcoat to the substrate, and provides additional opacity to the marker, particularly in environments in which the marker is exposed to water or solvents. This layer is also important in providing water, solvent and high humidity resistance to the marker. This layer is typically 0.5 to 50, preferably 1 to 25 and more preferably 2 to 15, μm in thickness.

Representative topcoats include Formulations 1-5 in following Table 1. The Comparative Formulation comprises a binder with a low, e.g., about 35 dyne per centimeter (dyn/cm), surface energy. All amounts are in weight percent.

TABLE 1
Five Inventive and One Comparative Topcoat Formulations

| | Formulation | | | | | |
|---|---|---|---|---|---|---|
| Component | 1 | 2 | 3 | 4 | 5 | Comp. Form.. |
| Elvamide ® 8063 | 10.79 | 11,17 | 11.54 | 11.94 | | |
| Michem ® Prime 4990R | | | | | 33.47 | |
| Ethylene/acrylic acid | | | | | | |
| copolymer | | | | | | |
| NeoCryl ® XK-101 acrylic | | | | | | 31.66 |
| dispersion | | | | | | |
| Syloid ® C812 silica gel | | 10.32 | | | | |
| Syloid ® C805 silica gel | | | | 9.73 | 12.21 | |
| Syloid ® C803 silica gel | 10.55 | | | | | |
| Fuji Sylysia SY 310P | | | 10.04 | | | |
| Silica gel | | | | | | |
| Syloid ® W500 silica gel | | | | | | 12.40 |
| Tinuvin ® 1130 UV absorber | 0.84 | 0.84 | 0.84 | | | |
| Tinuvin ® 460 UV absorber | | | | 0.84 | 0.84 | |
| Chimassorb ® 944 HALS* | 0.21 | 0.21 | 0.21 | 0.21 | | |
| Tinuvin ® HALS± | | | | | 0.21 | |
| Methanol | 1.95 | 1.95 | 1.95 | 1.95 | 1.95 | |
| n-Propanol | 58.59 | 58.47 | 58.40 | 58.33 | | |
| n-Butanol | 1.95 | 1.95 | 1.95 | 1.95 | 1.95 | |
| Deionized water | 14.65 | 14.62 | 14.60 | 14.58 | 48.86 | 50.94 |
| Xama-7 aziridine | 0.47 | 0.47 | 0.47 | 0.47 | 0.60 | |
| Cymel ® 385 melamine- | | | | | | 5.00 |
| Formaldehyde resin | | | | | | |
| Total | 100 | 100 | 100 | 100 | 100 | 100 |
| % Solids | 22 | 22.2 | 22.3 | 22.4 | 24.1 | 29.2 |
| P:B ratio | 0.90 | 0.85 | 0.80 | 0.75 | 1.00 | 1.00 |

*HALS means hindered amine light stabilizer.

The topcoat covers at least a part of the top facial surface of the facestock layer, typically at least 10, preferably at least 20 and more preferably at least 30, percent of the total surface area of the top facial surface of the facestock layer. The topcoat covers less than 100, typically less than 80 and more typically less than 50, percent of the total surface area of the top facial surface of the facestock layer. This partial covering of the top facial surface of the facestock by the topcoat allows the label to be wound around a wire such that the non covered top surface of the facestock can self-laminate over the printed images to form a protective layer.

Aqueous inkjet inks generally contain large weight fractions of liquid (85-100%), because most inkjet printheads used in home and office applications cannot jet inks with viscosity greater than 10 centipoise (cP). Even most industrial inkjet printheads cannot jet inks with viscosity greater than 30 cP. Several water-miscible co-solvents are often added to ink formulations to solubilize binder resins, to modify the viscosity of the inks, and as “humectants” so as to prevent the inkjet nozzles from drying out when the printer is not in use. Colorants may be either pigments or dyes. Pigments, by definition, are insoluble particles, whereas dyes are soluble in the medium in which they used. In general, pigments are more solvent-resistant and have better light fade resistance than dyes. However, the pigment particles must be ground to small particle sizes in order to pass through inkjet nozzle, which are often 20-40 microns in diameter. Average pigment particle sizes of 50-200 nm are common. In order to keep the viscosity of the ink low, the pigment content is often only 3-6% by weight. The pigment particles are typically coated with pigment dispersants, which may also double as binder resins that help the pigment particles adhere to the substrate. Polymer binder resins that are not also pigment dispersants are also common. Since dispersions or solutions of polymers quickly increase in viscosity as the polymer concentration increases, the amount of binder resin present in aqueous inkjet inks is usually kept below 10%. Additives such as light stabilizers, surfactants, antioxidants and biocides may also be present in small quantities.

The adhesive layer can be applied to bottom facial surface of the substrate by any conventional means including, but not limited to, lamination, printing and coating. The adhesive is transparent, and it is preferably a pressure sensitive adhesive (PSA). Many conventional pressure sensitive adhesives can be used in the practice of this invention and include but are not limited to waterborne acrylics, solvent-borne acrylics, epoxies, silicones, natural and synthetic rubbers, rubber-acrylic, hybrids, etc., and these can be used either alone or in combination with one another. The thickness of the adhesive layer can vary to convenience, but it is typically of 6 to 100, preferably of 12 to 60 and more preferably of 20 to 50, μm.

The construction of the release liner is not particularly important to the practice of this invention and its purpose, of course, is to protect the adhesive until the label is ready for application to a wire or cable. Examples of materials that can be used for the liner include glassine paper, laminated paper, polyester film, polypropylene film, polyethylene terephthalate (PET) film, preferably each of which has been subjected to a coating of silicone. The thickness of the liner layer can vary to convenience, but it is typically of 20 to 120, preferably of 40 to 100, μm.

The markers of this invention can be constructed in any convenient manner. Typically, the primer is printed on the substrate using an appropriate method like flexographic, screen or gravure printing. The topcoat is then applied in a similar manner to the primer. The pressure sensitive adhesive is then either printed or laminated to the bottom planar surface of the facestock, and a liner is then applied to the exposed surface of the adhesive.

The markers of this invention are used in the same manner as known markers, and they possess good conformity such that they can be wrapped around a wire or cable, typically a wire or cable that has a thickness greater than 2 millimeters (mm).

### Specific Embodiments

Self-laminate wire marker samples are created by screen printing a primer through a 420 mesh screen, screen printing two humps (i.e., layers) of the printable coating (Formulation 2 and Comparative Formulation of Table 1) through a 110 mesh screen, and then drying the printable coating with an infrared lamp and fan. The topcoat coating weight for all examples is in the 15-30 g/m² range. CMYK color blocks are printed at 100% ink laydown with an Epson Stylus C88+ inkjet printer in Photo Mode. In order to measure the opacity, the opaque area of a label is adhered to both the white and black areas of a BYKO Opacity Chart. The Y value in CIE94 Yxy color space is measured on both the Hack and white areas using an X-Rite 528 Spectrodensitometer with a D65 illuminant and 2° observer. The opacity is reported as the ratio of Y_{black} to Y_{white} expressed as a percentage. The influence of the primer in increasing the opacity and preserving the opacity when wet may be observed in Table 2.

The ink receptivity and absorption capacity of the material may be evaluated by printing test patterns of colored boxes surrounded by black borders of uniform width. The lateral spread of the border lines serves as a figure of merit that illustrates the effect of the use of a binder resin with low surface energy (e.g., NeoCryl® XK-101, with a surface energy of approximately 35 dyn/cm) in the Comparative Example of Table 1 for which line broadening and image bleeding is very significant. For inventive topcoat formulation 2 of Table 1 (which has a binder resin with a high surface energy (Elvamide 8063 polyamide, with a surface energy of approximately 52 dyn/cm)), line broadening is small.

TABLE 2
Testing of Self-Laminate Wire Marker Constructions

| Material Construction | | | | Opacity | | Ink Receptivity |
|---|---|---|---|---|---|---|
| | | | Printable | | After 1 hr | Printed Line |
| Number | Substrate | Primer | Coating | Dry | Water soak | Width* (mm) |
| 1 | 3 mil vinyl | Sericol | Formulation 2 | 77.8 | 65.4 | 0.8 |
| | | 650S37148SC | | | | |
| | | Screen White | | | | |
| 2 | 3 mil vinyl | None | Formulation 2 | 52.5 | 36.6 | 0.8 |
| 3 | 1 mil PET | None | Formulation 2 | 51.7 | 27.7 | 0.8 |
| 4 | 2 mil PET | None | Comp. Ex. | No Test | No Test | 1.7 |

*Printed line width of black border around yellow box both printed at 100% ink coverage on an Epson Stylus C88+ printer. In print file, the width of the border is 0.7 mm.

Although the invention has been described in considerable detail by the preceding examples and references to the drawings, this detail is for the purpose of illustration and is not to be construed as a limitation upon the spirit and scope of the invention as it is described in the appended claims. All patents and publications cited above, specifically including for U.S. practice all U.S. patents, allowed patent applications and U.S. patent application publications, are incorporated herein by reference.

What is claimed is:

1. An inkjet-printable, self-laminating label comprising:
A. A translucent or transparent substrate layer having top and bottom facial surfaces;
B. A topcoat layer having top and bottom facial surfaces with the bottom facial surface of the topcoat layer in direct contact with at least a part but not all of the top facial surface of the substrate layer, the top coat layer of a coating weight of at least 12 g/m² and comprising (1) pigment particles having (a) a number average particle size of 1 to 25 microns (μm), and (b) at least one of (i) an oil absorption value of at least 150 grams per 100 grams of particles (g/100 g), and (ii) a pore volume of at least 1.2 cubic centimeters per grain (cm³/g), and (2) water-insoluble binder resin having a surface energy greater than 42 dyne per centimeter (dyne/cm), the pigment particles and binder resin present at a weight ratio of at least 0.6; and
C. A translucent or transparent adhesive layer having top and bottom facial surfaces with the top facial surface of the adhesive layer in direct contact with the bottom facial surface of the substrate layer; and
D. An optional release liner having top and bottom facial surfaces with the top facial surface of the optional release liner in direct contact with the bottom facial surface of the adhesive layer.

2. The label of claim 1 in which the substrate layer is transparent and comprises polyolefin, polyester, PVC, polyamide, polyether or polyimide.

3. The label of claim 2 in which the topcoat layer comprises silica particles.

4. The label of claim 3 in which the binder resin is crosslinked.

5. The label of claim 4 in which the binder resin is alcohol soluble.

6. The label of claim 5 in which the binder resin is a polyamide.

7. The label of claim 1 in which the binder resin is a dispersion of a non-cationic, water-insoluble nylon terpolymer.

8. The label of claim 1 in which the adhesive layer comprises at least one of a waterborne acrylic, solvent-borne acrylic, epoxy, silicone, natural or synthetic rubber or a rubber-acrylic hybrid.

9. The label of claim 1 attached to a wire, cable or pipe.

10. The label of claim 1 in which the surface energy of the binder resin is at least 44 dyne/cm.

11. An inkjet-printable, self-laminating label comprising:
A. A translucent or transparent substrate layer having top and bottom facial surfaces;
B. An opaque white primer layer having top and bottom facial surfaces with the bottom facial surface of the primer layer in direct contact with at least a part but not all of the top facial surface of the substrate layer;
C. A topcoat layer having top and bottom facial surfaces with the bottom facial surface of the topcoat layer in direct contact with the top facial surface of the substrate layer, the topcoat layer of a coating weight of at least 12 g/m² and comprising (1) pigment particles having (a) a number average particle size of 1 to 25 microns (μm), and (b) at least one of (i) an oil absorption value of at least 150 grams per 100 grams of particles (g/100 g), and (ii) a pore volume of at least 1.2 cubic centimeters per gram (cm³/g), and (2) water-insoluble binder resin having a surface energy greater than 42 dyne per centimeter (dyne/cm), the pigment particles and binder resin present at a weight ratio of at least 0.6; and
D. A translucent or transparent adhesive layer having top and bottom facial surfaces with the top facial surface of the adhesive layer in direct contact with the bottom facial surface of the substrate layer; and
E. An optional release liner having top and bottom facial surfaces with the top facial surface of the optional release liner in direct contact with the bottom facial surface of the adhesive layer.

12. The label of claim 11 in which the substrate layer is transparent and comprises polyolefin, polyester, PVC, polyamide, polyether or polyimide.

13. The label of claim 12 in which the topcoat layer comprises silica particles.

14. The label of claim 13 in which the binder resin is crosslinked.

15. The label of claim 14 in which the binder resin is alcohol soluble.

16. The label of claim 15 in which the binder resin is a polyamide.

17. The label of claim 11 in which the binder resin is a dispersion of a non cationic, water-insoluble nylon terpolymer.

18. The label of claim 11 in which the adhesive layer comprises at least one of a waterborne acrylic, solvent-borne acrylic, epoxy, silicone, natural or synthetic rubber or a rubber-acrylic hybrid.

19. The label of claim 11 attached to a wire, cable or pipe.

20. The label of claim 11 in which the surface energy of the binder resin is at least 44 dyne/cm.
